(19) United States
(12) Patent Application Publication
(10) Pub. No.: US 2006/0239487 A1
(43) Pub. Date: Oct. 26, 2006

(54) Simulated rock speaker assembly

(76) Inventor: Adam L. Barker, Woodland Hills, CA (US)

Correspondence Address: MCDERMOTT, WILL & EMERY (LOS ANGELES OFFICE), 2049 CENTURY PARK EAST, 34TH FLOOR, LOS ANGELES, CA, 90067-3208, US

(21) Appl. No.: 11/111,037

(22) Filed: Apr. 21, 2005

(51) Int. Cl. H04R 1/02

(52) U.S. Cl. 381/349

(57) ABSTRACT

Methods and structures for providing a simulated rock speaker cabinet are disclosed herein. A simulated rock speaker includes a hollow casing having an interior surface, an exterior surface, and at least one port extending through and between the interior and exterior surfaces. A substantially even bottom edge forms a boundary around an open end of the hollow casing, and a speaker mounting assembly is coupled to the interior surface and substantially aligned with the at least one port. The exterior surface of the simulated rock speaker cabinet has an irregular finish simulating the configuration of a natural rock. A speaker coupled to the speaker mounting assembly aligns with the port to produce high quality sound without utilizing a visible grill in the exterior surface.

### BACKGROUND

1. Field of the Disclosure

The disclosures herein relate to aesthetically pleasing speakers for outdoor use. More particularly, the disclosures herein relate to novel speaker cabinets that bear a realistic appearance of a natural outdoor rock and conceal a speaker within.

2. Description of Related Art

People generally enjoy spending time in the outdoors, such as in the backyards of their homes. People also enjoy listening to music from their radios or stereos. However, combining these two activities has posed certain challenges in the past.

Listening to music in the outdoors imposes design considerations not typically encountered in environments protected from demanding weather conditions, partly because outdoor environments are generally not suitable for traditional speakers and speaker components. Humidity, temperature, and other factors that are not an issue in most climate-controlled environments have a negative and potentially destructive effect on such equipment. One option for a person who desires outdoor music is to carry a portable stereo outside for temporary use, and store it inside in between uses. Unfortunately, this process is cumbersome, particularly for a person who seeks to enjoy outdoor music for the very purpose of relaxing. Another option is to permanently install weatherproof speakers outdoors. Certain speakers have been engineered for outdoor use, such as on boats or in outdoor entertainment venues. However, due to their typically rugged and robust designs, such speakers are often unattractive and detract from the aesthetic appeal of an outdoor environment.

In the past, attempts were made to hide speakers in outdoor environments by disguising the speakers so that they bore the resemblance of some element common to the outdoor environment in which they would be placed. FIG. 1 illustrates a speaker 100 in an attempted rock disguise. Other speakers have been disguised as trees and architectural elements. Unfortunately, due to the requirements of housing speakers and providing weather proof characteristics, these disguises are unrealistic and are easily detected in an outdoor garden even by the casual observer. For example, in the speaker rock example, a grill 102 provides openings through which sound from the speaker may pass. Unfortunately, since real rocks do not have grills, these speaker rocks are very noticeable in a natural outdoor environment. The disguised speaker rock cannot merely be turned around to hide the grill, because doing do would cause sound from the speaker to travel in the wrong direction. Moreover, the shape and construction of speaker enclosures have significant impact on the quality of sound that may be produced from speakers housed therein. The shape of the enclosure, selection of materials, and inclusion of a grill on the speaker rocks illustrated in FIG. 1 may fail to produce sound of the quality sought by some sound enthusiasts.

Because of these difficulties, and other complexities involved in designing a speaker cabinet to have the multiple functions of blending into the outdoors, preserving or enhancing the speaker's sound qualities, and protecting the speaker from harsh outdoor environments, there is not currently a suitable aesthetic outdoor speaker cabinet.

### SUMMARY OF THE PRESENT DISCLOSURES

In view of the various problems discussed above, there is a need for an improved mechanism for producing high quality sound from aesthetically pleasing structure having a realistic appearance that can both tolerate and blend into outdoor environments.

In one aspect of the present teachings, a simulated rock speaker cabinet includes a hollow casing having an interior surface, an exterior surface, and at least one port extending through and between the interior and exterior surfaces. A substantially even bottom edge forms a boundary around an open end of the hollow casing, and a speaker mounting assembly is coupled to the interior surface and substantially aligned with the at least one port. The exterior surface of the simulated rock speaker cabinet has an irregular finish simulating the configuration of a natural rock.

In another aspect of the present teachings a simulated speaker rock includes a simulated rock speaker cabinet having a hollow casing, wherein the hollow casing has an interior surface, an exterior surface, at least one port extending through and between the interior and exterior surfaces. A substantially even bottom edge forms a boundary around an open end of the hollow casing, and a bottom surface is coupled to the bottom edge and covers the open end to enclose the hollow casing. A speaker mounting assembly is coupled to the interior surface and to the bottom surface, and a speaker is coupled to the mounting assembly and substantially aligned with the at least one port. The exterior surface of the simulated speaker rock has an irregular finish simulating the configuration of a natural rock.

In another aspect of the present teachings, a simulated speaker rock includes a simulated rock speaker cabinet having a hollow casing, wherein the hollow casing has an interior surface, an exterior surface, and a substantially even bottom edge that forms a boundary around an open end of the hollow casing. At least one port extends through and between the interior and exterior surfaces. A hollow channel extends into the hollow casing, the hollow channel having a first end at the exterior surface and a second end within the hollow casing. A bottom surface is coupled to the bottom edge and covers the open end to enclose the hollow casing. A speaker mounting assembly is coupled to the interior surface and to the bottom surface, and a speaker is coupled to the mounting assembly and substantially aligned with the second end of the hollow channel. An exterior surface of the simulated speaker rock has an irregular finish simulating the configuration of a natural rock.

It is understood that other embodiments of the present disclosures will become readily apparent to those skilled in the art from the following detailed description, wherein it is shown and described only exemplary embodiments of the present disclosures by way of illustration. As will be realized, the teachings herein are capable of other and different embodiments and its several details are capable of modification in various other respects, all without departing from the spirit and scope of the present disclosures. Accordingly, the drawings and detailed description are to be regarded as illustrative in nature and not as restrictive.

### BRIEF DESCRIPTION OF THE DRAWINGS

Aspects of the present disclosures are illustrated by way of example, and not by way of limitation, in the accompanying drawings, wherein:

FIG. 1 illustrates a prior art speaker enclosure;

FIG. 2 illustrates basic speaker components that may be used to produce sound waves;

FIG. 3. illustrates an example of a bass reflex speaker enclosure; and

FIG. 4 illustrates a speaker enclosure having the form of a simulated rock.

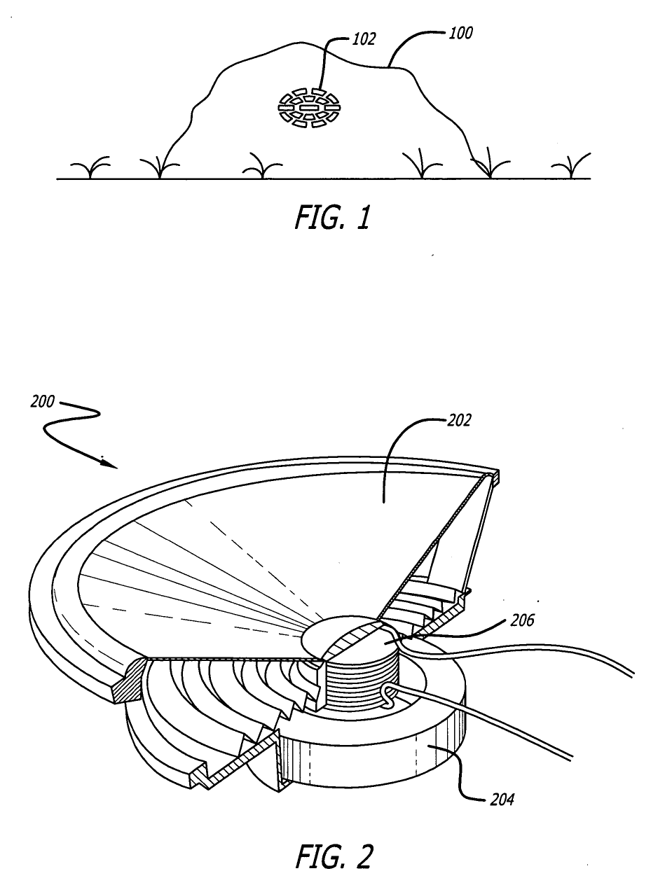

### DETAILED DESCRIPTION OF ILLUSTRATIVE EMBODIMENTS

The detailed description set forth below in connection with the appended drawings is intended as a description of various embodiments of the present disclosures and is not intended to represent the only embodiments in which the teachings herein may be practiced. Each embodiment described in this disclosure is provided merely as an example or illustration of the present disclosures, and should not necessarily be construed as preferred or advantageous over other embodiments. The detailed description includes specific details for the purpose of providing a thorough understanding of the teachings herein. However, it will be apparent to those skilled in the art that the teachings may be practiced without these specific details. In some instances, well-known structures and devices are shown in block diagram form in order to avoid obscuring the concepts of the present disclosures.

In any sound system, sound quality ultimately depends on the speakers, which serve as the interface between the system and a listener. In general terms, a speaker is a sound system component that receives electronic signals stored on media such as CDs, tapes and DVDs, and converts the signals into sound that can be heard by a listener. Sound travels in waves of air pressure fluctuation. Accordingly, speakers produce sound by causing certain subcomponents to vibrate, moving the air particles around them in a wave-like pattern to carry the pulse of the vibration through the air as a traveling disturbance. When this sound wave reaches a person's ear, it vibrates the eardrum back and forth, causing the person's brain to interpret the motion as sound.

Sound may have different variations depending on the nature of the speaker producing the sound. Sound-wave frequency and air-pressure level are two factors that may cause variations in sound. A higher wave frequency is caused by faster fluctuations in air pressure and translates to a higher pitch. Conversely, lower wave frequencies cause lower pitch. Air-pressure level refers to the traveling sound wave's amplitude, or size. Amplitude determines how loud the sound is. Sound waves having greater amplitudes produce louder sounds, while small amplitude waves produce a lower volume.

FIG. 2 illustrates some of the basic speaker components that may be used to produce these sound waves. The speaker may include a driver 200, which produces sound waves by rapidly vibrating a flexible diaphragm 202, also commonly referred to as a “cone.” Alternating current produced by an amplifier attached to the speaker causes the polar orientation of an electromagnet 204 to rapidly and repeatedly reverse direction. The electromagnet 204 may be coupled to the diaphragm 202, such as through a voice coil 206, in turn causing the diaphragm 202 to vibrate.

Drivers and other speaker components may be housed within a speaker enclosure. In addition to conveniently packaging the components into a single integrated unit, a speaker enclosure provides stability and affects the speaker's sound quality. Enclosures are typically built from heavy wood or another solid material to effectively absorb the driver's vibration. Without absorbing these vibrations, they could translate to outside structures, causing them to rattle, make noise, and obscure much of the speaker's sound. Also, a speaker enclosure serves to handle a driver's “backward” waves. Since the driver's diaphragm moves back and forth as described above, it produces sound waves behind the cone in addition to the front sound waves that produce most of the speaker's sound. A speaker enclosure may be designed in different ways to handle these backward waves and control their effect on the speaker sound.

One type of speaker enclosure is a sealed enclosure, sometimes referred to as an acoustic suspension enclosure. This type of enclosure is completely sealed so that no air can escape. The forward wave produced by the driver travels outward into the room, while the backward wave produced behind the driver's diaphragm travels only into the enclosure. Because the backward wave cannot escape the sealed enclosure, pressure inside the enclosure constantly fluctuates. In order to overcome the force of air pressure within the enclosure, the amplifier connected to the speaker must boost its electrical signal, causing this type of speaker enclosure to be less efficient than other designs.

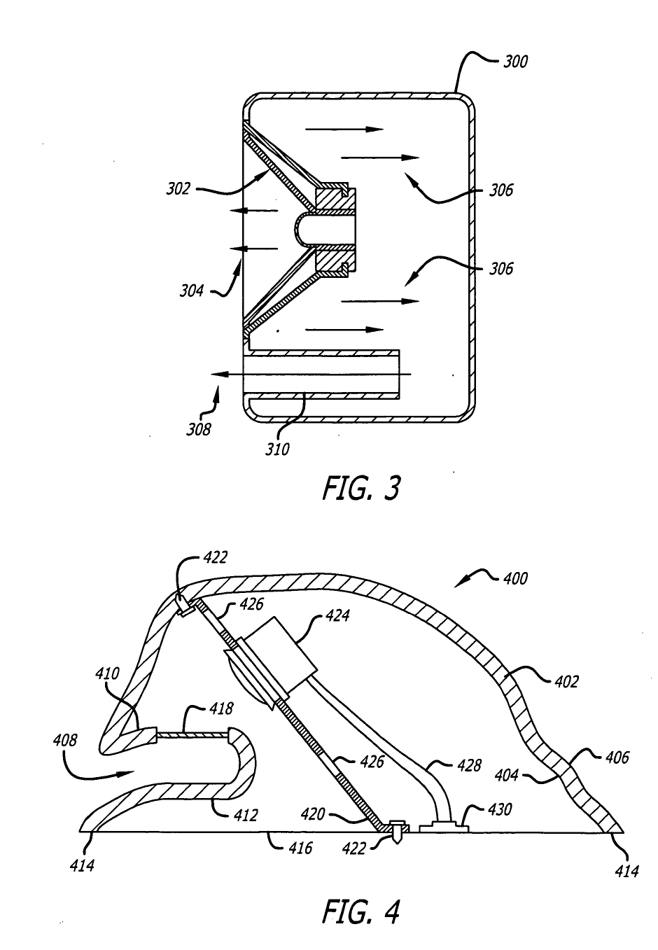

A more efficient type of enclosure design is not sealed and instead incorporates a feature referred to herein as a “port.” Bass reflex speakers use this type of enclosure, which redirects the inward pressure (from behind the driver's diaphragm) outward, using it to supplement the forward sound wave. FIG. 3 illustrates one example of a bass reflex enclosure 300. When the diaphragm 302 moves outward during a vibration it produces a forward wave 304. When the diaphragm 302 moves inward during the vibration, it produces a backward wave 306 that pushes sound waves 308 out of the port 310, boosting the overall sound level. Thus, the power moving the driver is used to emit two sound waves rather than one, causing this to be a more efficient type of enclosure.

In short, the design and structure of a speaker enclosure has a significant impact on the sound produced by the speaker held within. The speaker enclosures disclosed herein are formed with an appropriate shape and appropriate materials to preserve or enhance speaker sound.

FIG. 4 illustrates a speaker enclosure having form of a simulated rock, such that it blends into an outdoor environment without being noticeable. The simulated rock speaker cabinet 400 may include a hollow casing 402 having an interior surface 404 and an exterior surface 406. The exterior surface 406 may have an irregular finish simulating the configuration of a natural rock. The irregular finish may comprise, for example, variegated texture and color. An opening 408 may extend through and between the interior and exterior surfaces. The opening 408 may comprise a hollow channel that extends into the hollow casing 402. The hollow casing 402 may further comprise an upper lip 410 and a lower lip 412, and the opening 408 may extend through the upper lip 410 such that it is hidden from view when the simulated rock speaker cabinet is viewed from the outside. The opening 408 may comprise a speaker port when a driver is mounted inside the enclosure, or may operate in conjunction with a speaker port when a speaker is mounted inside the enclosure, to direct sound from within the simulated rock speaker cabinet 400 in an efficient and sound enhancing manner. In this aspect of the disclosures herein, simulated rock speaker cabinet 400 may include a sound opening that is hidden from view such that a person would not discern that the simulated rock speaker cabinet is not a real rock.

A bottom edge 414 may form a boundary around an open end of the hollow casing 402. The bottom edge 414 may be substantially even such that it may be securely coupled to a bottom surface 416, leaving no openings through which moisture or other contaminates could enter the enclosure. The bottom surface 416 may be pre-assembled with the speaker enclosure, or may be comprise the mounting surface on which the speaker enclosure is installed and mounted. If the bottom surface 416 is pre-assembled with the speaker enclosure, the bottom surface 416 may be placed directly on the ground, and may operate both to stabilize the simulated rock speaker cabinet 400 and to prevent moisture and other outdoor elements from entering the interior of the hollow casing 402. Alternatively, the bottom edge 414 may be placed on the mounting surface, and the mounting surface may be sufficiently adhered to the bottom edge 414 such that moisture and other outdoor elements are prevented from entering the interior of the hollow casing 402, in which case the mounting surface serves as the bottom surface 416. An optional screen 418 may be placed within the opening 408 and coupled to the upper lip 410 so that bugs and other outdoor elements are prevented from entering the hollow casing 402 through the opening 408.

A speaker mounting assembly 420 may be coupled to the interior surface 404 and the bottom surface 416, and aligned with the opening 408. The speaker mounting assembly 420 may be aligned such that it is substantially perpendicular to the bottom surface 416, and may be coupled to the hollow casing 402 by suitable connectors 422 such as, for example, rivets, bolts, screws or other mechanical coupling devices. The speaker mounting assembly 420 may also be set at an angle as illustrated in FIG. 4, so that the speaker 424, when mounted on the speaker mounting assembly 420, is substantially aligned with the opening 408. The speaker mounting assembly 414 may also be bonded, adhered or otherwise attached directly to the speaker enclosure. A speaker 424, or a driver, may be coupled to the speaker mounting assembly 420 and aligned with the opening 408 so that sound produced by the speaker driver is directed substantially through the opening 408. Holes 426 may be placed in the speaker mounting assembly so that backward waves produced by the speaker 424 may be reflected off the interior surface 404, travel through the holes 426 and through the opening 408. The holes 426 may therefore assist in producing a bass reflex system as described above. The holes 426 may comprise, for example, four separate holes each having an approximately 1.5 inch diameter placed around the speaker 424. However, the number of holes may be varied to provide an appropriate space for backward waves to travel through the speaker mounting assembly 420 and into the opening 408. The combined diameter of the holes 426 may, for example, comprise approximately the same value as the outer diameter of the speaker 424. For example, if the speaker has a 6 inches diameter, the sum of diameters of the holes 426 may total approximately 6 inches. If there are four holes 426, each hole may have a diameter of approximately 1.5 inches. Of course, these values are provided only as examples and the teachings herein are not limited to use with these particular examples. Moreover, the number of holes 426 may be varied, and their size as compared to the size of the speaker 424 may also vary.

When the speaker 424 is substantially aligned with the opening 408, forward waves produced by the speaker 424 and backward waves produced by the speaker 424 and directed through the holes 426, may propagate through the optional screen 418 and into the opening 408. Leads 428 from the speaker 424 may be directed through a secure opening 430 in the bottom surface 416 so that they are available to be attached to an amplifier or other driving means. The secure opening 430 may comprise a rubberized or silicone collet or other securing mechanism for allowing enough space to accommodate wire leads while being tight enough to resist moisture and other outdoor elements.

The simulated rock speaker cabinet 400 may be constructed to have additional features built in to its shape. For example, the outside surface of the simulated rock speaker cabinet may be formed to have a ledge suitable for use as a seat. The simulated rock speaker cabinet may also be formed to include a cup holder in its outer surface. Those skilled in the art will appreciate that many other variations are possible as well. Also, the simulated rock speaker cabinet 400 may be sized to house various types of speakers. For example, smaller simulated rocks may house tweeters for producing high frequency sound, medium sized simulated rocks may enclose mid-range speakers and large simulated rocks may be constructed to enclose woofers, which produce low frequency base sound.

In order to have material properties sufficient to absorb vibrations produced by the speaker drivers, yet light enough to be manageable, a simulated speaker rock made in accordance with the teachings disclosed herein may comprises a series of layers, each formed with materials chosen for their high ratios of strength and structural integrity to weight, and for their weatherproof and waterproof qualities. The hollow casing 402 may comprise three or more distinct layers, wherein the layers include a body coat closest to the interior of the hollow casing, a face coat forming the exterior of the simulated speaker rock, and a middle coat situated between the body and face coats. Each of these three coats may individually comprise one or more layers of material.

The body coat may comprise a combination of heat activated cement and color. The heat activated cement may comprise, for example, RAPIDSET CEMENT ALL or a composition of cement and heat activated plaster. The cement may provide the simulated speaker rock with weatherproof and waterproof qualities. Heat activated plaster within the cement may provide tensile strength to enhance the sound quality of the simulated rock speaker cabinet. Another benefit of the heat activated plaster is that it may reduce manufacturing time. The color may comprise, for example, concrete color or other dry colorant, and may be added to the heat activated cement before it is mixed with water to create the wet cement that may be formed into one or more layers for the body coat. The middle coat, which may be arranged on top of the body coat, may comprise a combination of heat activated cement, color and fiberglass roving. The fiber roving may comprise, for example, fiberglass rope chopped into approximately 1-inch lengths. Those skilled in the art will recognize that other forms and sizes of fiber roving materials may also be successfully employed to provide strength to the middle coat. The outer surface of the simulated speaker rock comprises the face coat. The face coat, which may be arranged on top of the middle coat, may comprise heat activated cement and color, as described above with reference to the body coat.

To construct a simulated speaker rock in accordance with the disclosures herein, a model of the desired rock shape may be formed out of foam. Foam, such as that produced with an A+B 2-part foam kit for example, may be sprayed on a work bench to form the general shape of a rock. After the foam hardens, it may be carved and textured to form a model having the desired specific rock shape. A channel in the shape of a port may carved into a side of the model such that it extends into the model but not all the way through it. The channel may be formed to include an overhang so that the port in a finished speaker rock will be hidden by a protruding upper lip. After the general shape including a port location is achieved, the model may be textured using plaster, sand, sponges and other appropriate tools. For example, a combination of 95% Structolite and 5% cement may be hand applied onto the model to build up material in certain areas where it may be needed. Particular care may be taken to apply sufficient material around the port such that it is well defined and includes sufficient overhang of the upper lip. Silica sand may be applied to the surface of the model through a hopper, creating an uneven and textured surface. Additional texture may be achieved through sponging and hand trowel carving.

After the model is complete, a flexible mold may be fashioned in accordance with the shape of the model. The flexible mold may then be used to manufacture a series of simulated rock speaker cabinets. To create the flexible mold, a series of rubber or silicone layers and intervening material layers may be brushed directly on top of the model. For example, the model may first be brushed with two coats of silicone, then a layer of cheesecloth may be applied. Another layer of silicone, a second layer of cheesecloth and a final layer of silicone may then be applied. During the layering process, care may be taken to ensure that the port in the model is also coated with silicone and layered with cheesecloth, so that the flexible mold includes a port. When the mold has reached sufficient thickness to achieve the structural integrity required for repeated use during the manufacturing process, the layering may be discontinued and the flexible mold allowed to dry. After the flexible mold dries and solidifies on top of the model, foam such as A+B foam may be sprayed into the port to form a plug. The foam plug may be shaved such that it is approximately flush with the outside of the flexible mold on the model.

Next, a case may be formed for holding the flexible mold. The case may be formed directly on top of the flexible mold before the flexible mold is removed from the model. The case may comprise a mixture of approximately equal portions of plaster and hemp applied when wet, though other materials will also be sufficient. The wet mixture may be hand applied to the flexible mold on the model in thin layers that cover the silicone. Two to three layers, each approximately ¼″ thick, may be applied to build the case. Once the case has set, it may be removed from the model. One possible technique for easily removing the case from the model is to direct compressed air around the outside perimeter of the case, between the case and the flexible mold. Wedges may be driven around the perimeter to lift the case away from the model with even pressure. Next, the plug may be removed from the model, and the flexible mold may be peeled away from the model. The plug may then be reinserted into the flexible mold, and the flexible mold and plug may be reinserted into the case. The combined case, flexible mold and inserted plug collectively constitute a manufacturing mold that may be used for a series of manufacturing runs to produce simulated rock speaker cabinets.

To create a simulated rock speaker cabinet, the manufacturing mold may have layers of different materials applied to it to form the body, middle and face coats, as described above. First, colorant such as concrete color may be mixed with water and applied to the manufacturing mold to create a variegated color surface that will transfer to the face coat. The color may be applied, for example, by spattering the inner surface of the manufacturing mold with a paint brush or other paint applicator. Then, two layers of face coat material may be applied to the manufacturing mold. Though different thicknesses may be used, the first face coat layer may be approximately ¼ inch and the second face coat layer may be approximately ⅛ inch. One or more middle coats of the formulation described above may be applied next. Then one or two body coats, each approximately ⅛ inch thick, may be applied. Once the body coat, middle coat and face coat have set, the plug may be removed, and the flexible mold together with the set coats may be plied away from the case. The flexible mold may then be peeled away from the set coats, which now stand on their own to form the simulated rock speaker cabinet. The surface of the simulated rock speaker cabinet (i.e. the face coat) may be textured with color, for example by applying a color wash. The bottom edge of the simulated rock speaker cabinet may be cleaned up to remove rough edges.

Next, a speaker mounting assembly may be installed inside of the hollow simulated rock speaker cabinet. The speaker mounting assembly may comprise, for example, plastic or resin, and may be molded according to the process described above such that it scribes to the shape of the inner surface of the cabinet. It may be attached to the cabinet by mechanical attachment means as described above, or it may be adhered to the cabinet's interior such as with heat activated cement or an adhesive material. A ball of this material may be placed on the inside surface of the simulated speaker rock, and the speaker mounting assembly may be pressed into the material and allowed to set until the heat activated cement cures. Finally, a speaker may be installed in the speaker mounting assembly, and the simulated rock speaker cabinet may have its open end sealed by securing a bottom surface to the bottom edge of the speaker rock. The bottom surface may comprise, for example, plastic or resin. A hole may be formed in the bottom surface to accommodate speaker wires, and may be supplemented with a collet, silicone plug or other securing means. The securing means may be designed or selected to allow passage of the wires yet protect the speaker rock interior from water, moisture or other external elements.

The previous description of the disclosed embodiments is provided to enable any person skilled in the art to make or use embodiments of the present disclosures. Various modifications to these embodiments will be readily apparent to those skilled in the art, and the generic principles defined herein may be applied to other embodiments without departing from the spirit or scope of the teachings herein. Thus, the present disclosures are not intended to be limited to the embodiments shown herein but is to be accorded the widest scope consistent with the principles and novel features disclosed herein.

I claim:

1. A simulated rock speaker cabinet comprising:
a hollow casing having an interior surface, an exterior surface, and at least one port extending through and between the interior and exterior surfaces;
a substantially even bottom edge that forms a boundary around an open end of the hollow casing;
a speaker mounting assembly coupled to the interior surface and substantially aligned with the at least one port; and
the exterior surface having an irregular finish simulating the configuration of a natural rock.

2. The simulated rock speaker cabinet of claim 1 wherein the hollow casing comprises an upper lip and a lower lip, and wherein the port extends through the upper lip such that the port is hidden.

3. The simulated rock speaker cabinet of claim 1 wherein the bottom edge is coupled to a base portion such that the base portion covers the open end of the hollow casing and encloses the speaker mounting assembly therein.

4. The simulated rock speaker cabinet of claim 1 wherein the speaker mounting assembly comprises a speaker coupled thereto, such that the speaker is substantially aligned with the at least one port.

5. The simulated rock speaker cabinet of claim 1 wherein the irregular finish comprises a variegated surface and variegated colors.

6. The simulated rock speaker cabinet of claim 1 wherein the hollow casing comprises at least one middle coat of a first material composition and at least one face coat of a second material composition.

7. The simulated rock speaker cabinet of claim 6 wherein the first material composition comprises cement and fiber roving materials.

8. The simulated rock speaker cabinet of claim 7 wherein the cement comprises heat activated plaster.

9. The simulated rock speaker cabinet of claim 6 wherein the second material composition comprises cement and color.

10. The simulated rock speaker cabinet of claim 9 wherein the second material composition further comprises heat-activated plaster.

11. A simulated speaker rock comprising:
a simulated rock speaker cabinet having a hollow casing, wherein the hollow casing has an interior surface, an exterior surface, at least one port extending through and between the interior and exterior surfaces, and a substantially even bottom edge that forms a boundary around an open end of the hollow casing;
a bottom surface coupled to the bottom edge and covering the open end to enclose the hollow casing;
a speaker mounting assembly coupled to the interior surface and to the bottom surface;
a speaker coupled to the mounting assembly and substantially aligned with the at least one port; and
the exterior surface having an irregular finish simulating the configuration of a natural rock.

12. The simulated speaker rock of claim 11 wherein the hollow casing comprises an upper lip and a lower lip, and wherein the port extends through the upper lip such that the port is hidden.

13. The simulated speaker rock of claim 11 wherein the speaker mounting assembly comprises a speaker coupled thereto, such that the speaker is substantially aligned with the at least one port.

14. The simulated speaker rock of claim 11 wherein the hollow casing comprises at least one middle coat of a first material composition and at least one face coat of a second material composition.

15. The simulated speaker rock of claim 11 wherein the first and second material compositions comprise heat activated cement, and wherein the first material composition further comprises fiber roving materials.

16. A simulated speaker rock comprising:
a simulated rock speaker cabinet having a hollow casing, wherein the hollow casing has an interior surface, an exterior surface, and a substantially even bottom edge that forms a boundary around an open end of the hollow casing;
at least one port extending through and between the interior and exterior surfaces and having a hollow channel extending into the hollow casing, the hollow channel having a first end at the exterior surface and a second end within the hollow casing;
a bottom surface coupled to the bottom edge and covering the open end to enclose the hollow casing;
a speaker mounting assembly coupled to the interior surface and to the bottom surface;
a speaker coupled to the mounting assembly and substantially aligned with the second end of the hollow channel; and
the exterior surface having an irregular finish simulating the configuration of a natural rock.

17. The simulated speaker rock of claim 16 wherein the hollow casing comprises an upper lip and a lower lip, and wherein the first end of the hollow channel extends through the upper lip such that the port is hidden.

18. The simulated speaker rock of claim 16 wherein the hollow channel comprises a screen between the first and second ends.

19. The simulated speaker rock of claim 16 wherein the hollow casing comprises at least one middle coat of a first material composition including heat activated cement and fiber roving materials and at least one face coat of a second material composition including heat activated cement.

20. The simulated speaker rock of claim 19 wherein the hollow channel comprises at least one middle coat of the first material composition and at least one face coat of the second material composition.
